(19) United States
(12) Patent Application Publication
(10) Pub. No.: US 2008/0034753 A1
(43) Pub. Date: Feb. 14, 2008

(54) Turbocharger Systems and Methods for Operating the Same

(76) Inventors: Anthony Holmes Furman, Scotia, NY (US); Shishir Chandrasekhar Menon, Bangalore (IN); Kendall Roger Swenson, Erie, PA (US); Daniel Edward Loringer, Erie, PA (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/464,562

(22) Filed: Aug. 15, 2006

(51) Int. Cl. F02B 33/44; F02D 23/00

(52) U.S. Cl. 60/605.1; 60/601; 60/598

(57) ABSTRACT

Disclosed herein are turbocharger systems and methods for their operation. In one embodiment a turbocharger system is disclosed. The turbocharger system comprises a turbine, a compressor, an air inlet, a first sensor, a second sensor, and a controller. The turbine is mechanically connected to the compressor and the air inlet is connected in fluid communication to the compressor. The first sensor and the second sensor are connected in operational communication with the air inlet and disposed a sufficient distance from one another to be capable of measuring a temperature differential caused by a hot boundary layer. The controller is connected in operational communication with the first sensor and the second sensor, and the controller is configured to detect surge precursors.

### BACKGROUND

Turbochargers can be employed in many applications to increase the power output from internal combustion engines (e.g., gasoline or diesel). Especially desirable in large-bore application, such as diesel-powered locomotives, turbochargers achieve increased power by compressing intake air prior to mixing it with fuel. This results in the delivery of an increased quantity (e.g., mass) of the air/fuel mixture into the cylinders. Upon combustion, the increased quantity of the air/fuel mixture produces additional energy, which results in an increase in the power produced by the engine.

Generally, turbochargers comprise a compressor that is driven by a shaft. Connected to an end of the shaft that is opposite the compressor is a turbine, wherein the turbine, compressor and shaft are generally coaxial. The turbine is disposed within the flow stream of the engine's exhaust. As exhaust passes through the turbine, forces are exerted on the vanes of the turbine that cause it to rotate with respect to the volumetric flow rate of the engine's exhaust. Thus, as the exhaust flow rate increases, the rotational speed of the turbine will increase as well.

The operation of turbochargers can be described using a performance map having volumetric flow rate (at the inlet port) on the X-axis and a pressure ratio of outlet pressure to inlet pressure on the Y-axis. The compressor air flow rate and the pressure ratio vary with respect to the rotational velocity of the turbocharger.

The performance map is bound by three operating conditions: maximum rotational velocity, surging, and choking. To be more specific, surging is an operating condition wherein the volumetric flow rate at the inlet port is excessively low with respect to pressure ratio and the turbocharger is incapable of maintaining the outlet pressure. As a result, the flow through the compressor is temporarily reversed to relieve the outlet pressure. Once the pressure is relieved, normal flow through the turbocharger is restored and outlet pressure is again generated creating another condition wherein the turbocharger is incapable of maintaining the outlet pressure, and a pressure relieve cycle is repeated, thusly named surging. Choking is an operating condition that is caused when the compressor reaches its maximum output however the engine demands additional air, thus the engine is choked by the turbochargers flow rate. This operating condition can be the result of an undersized turbocharger or reduced rotational velocities as the result of wear or damage. This condition results in reduced turbocharger and engine efficiency.

When operated under surging or choked conditions, the operating efficiency of the turbocharger and/or engine is undesirably poor. However, when the turbocharger is operated within these boundaries efficiency is generally acceptable. To be even more specific, as the point of operation varies with respect to constant rotational velocity, higher efficiency can be achieved at higher pressure ratio and lower volumetric flow rate. Therefore, as the point of operation approaches the surge boundary, without experiencing the detrimental effects of a surging event, the turbocharger exhibits high efficiency and provides the desired high pressure ratio to meet the air demands of an emissionized diesel engine.

Many turbochargers operate as a slave to the exhaust output without employing any type of control system. However, methods for controlling turbocharger operation are intriguing as manufacturers strive for improved efficiency and system longevity. One exemplary method employs flow valves or variable ducting configured to control the amount of exhaust flow supplied to the turbine. Another exemplary method employs ducting or bleed valves to release compressor pressure to the atmosphere or turbine intake. Although these methods have demonstrated to be somewhat effective at altering the operating conditions of the turbocharger once a surging event occurs, they are incapable of predicting the onset of surging prior to an actual surging event.

Thus, there is a need in the art for a turbocharging system, and methods for its operation, that provides efficient, reliable turbocharger operation at high compressor pressure ratios.

### BRIEF SUMMARY

Disclosed herein are turbocharger systems and methods for their use.

In one embodiment a turbocharger system is disclosed. The turbocharger system comprises a turbine, a compressor, an air inlet, a first sensor, a second sensor, and a controller. The turbine is mechanically connected to the compressor and the air inlet is connected in fluid communication to the compressor. The first sensor and the second sensor are connected in operational communication with the air inlet and disposed a sufficient distance from one another to be capable of measuring a temperature differential caused by a hot boundary layer. The controller is connected in operational communication with the first sensor and the second sensor, and the controller is configured to detect surge precursors.

In another embodiment, a turbocharger system is disclosed. The turbocharger system comprises a turbine, a compressor, an air inlet, an air outlet, a first pressure sensor, a second pressure sensor, a wavelet function processor, and a controller. The turbine is mechanically connected to the compressor and the air inlet and the air outlet are connected in fluid communication to the compressor. The first pressure sensor is connected in operational communication with the air inlet, and the second pressure sensor is connected in operational communication with the air outlet. The wavelet function processor is connected in operational communication with the first pressure sensor and the second pressure sensor, and the controller connected in operational communication with the wavelet function processor.

In yet another embodiment, a method for controlling the operation of a turbocharger is disclosed. The method comprises, monitoring a temperature differential in an air inlet connected in fluid communication to a compressor, determining if the temperature differential is a surge precursor, and determining if an action is desirable, wherein if an action is desired, performing the action.

In another embodiment, a method for controlling the operation of a turbocharger is disclosed. The method comprises, monitoring a pressure using a controller, determining if the signal exhibits a surge precursor, and determining if an action is desirable, wherein if an action is desired, performing the action. The pressure is supplied to the controller in the form of a signal.

In another embodiment, a method for controlling the operation of a turbocharger is disclosed. The method comprises, receiving a signal by a controller from a sensor, processing the signal using a wavelet transform processor to produce a frequency band, determining if the frequency band exhibits a surge precursor, and determining if an action is desired. If an action is desired, the controller performs the action. The sensor is disposed in operational communication with the turbocharger.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a side view of an exemplary turbocharger.

FIG. 2 is an exemplary performance map.

FIG. 3 is an exemplary flowchart illustrating a method for predicting the onset of surge and the proximity of a surging event.

FIG. 4 is an alternative embodiment of a control system.

FIG. 5 is an exemplary graph illustrating the signal received from a temperature sensor when a turbocharger is operated without exhibiting any indications of the onset of surge.

FIG. 6 is an exemplary graph illustrating the signal received from a temperature sensor when a turbocharger is operated near the onset of surge.

FIG. 7 is an exemplary graph illustrating the signal received from a sensor when a turbocharger is operated at a point of operation close to the surge boundary.

FIG. 8 is an exemplary graph illustrating the signal received from a sensor when a turbocharger is operated in surging conditions.

FIG. 9 is a flow chart illustrating an exemplary process employing a wavelet transform.

### DETAILED DESCRIPTION

Disclosed herein are turbocharger (e.g., centrifugal turbocharger) systems comprising a turbocharger and a control system. The control system comprises a process controller capable of monitoring the operation of the turbocharger and detecting the onset of surging events prior to actual surge through monitoring surge precursors. Upon detecting the surge precursors, the process controller is capable of determining the proximity of a surging event and capable of adjusting the operating conditions of the turbocharger system to avoid surge, thereby maintaining efficient operation.

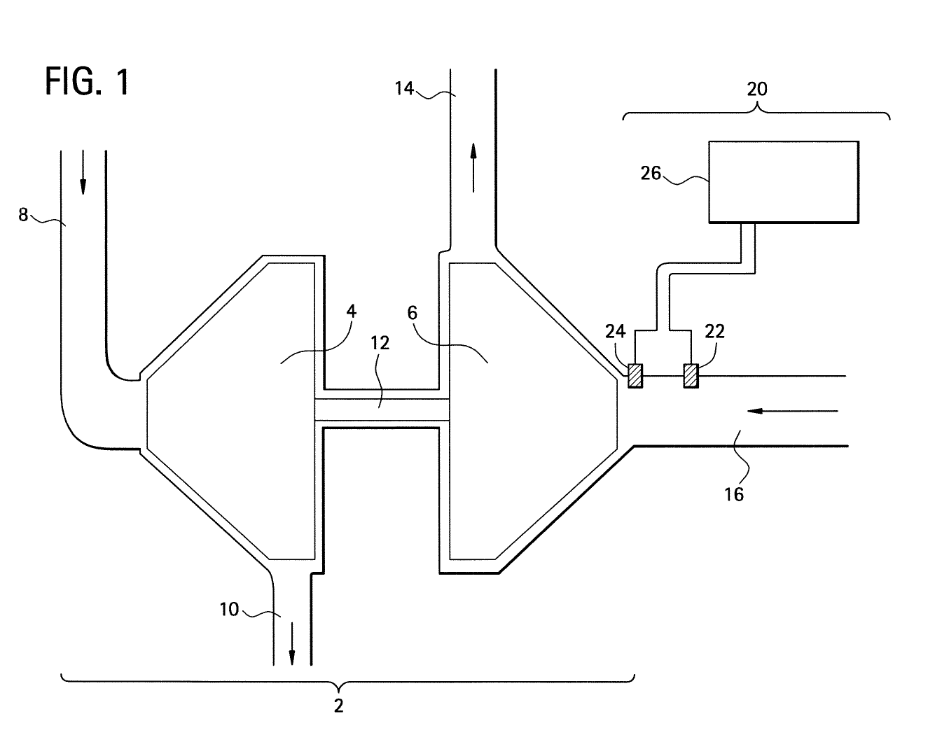

Illustrated in FIG. 1 is a side view of an exemplary turbocharger 2 comprising a turbine 4 and a compressor 6, which are mechanically connected by a shaft 12. The turbine 4 is connected in fluid communication with an exhaust inlet 8 and an exhaust outlet 10, which induces rotary motion of the turbine 4. The rotary motion of the turbine 4 drives the compressor 6, which is connected in fluid communication with air outlet 14 and an air inlet 16. The rotary motion of the compressor 6 draws air through the air inlet 16, compresses the air, and forces it out of the air outlet 14 at elevated pressure. The compressed air is then directed into the intake manifold of an internal combustion engine (not shown) where it is directed into the engine's cylinders, combined with fuel, and ignited.

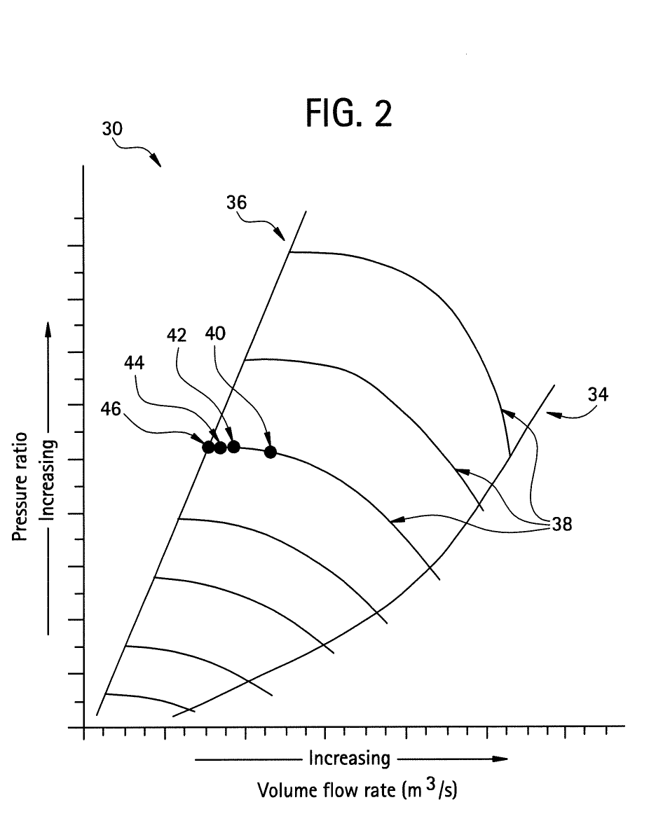

During operation, the turbocharger 2 operates in a dynamic manner wherein its operating variables change often. Despite these frequent changes, it is desirable that the turbocharger 2 operates with high efficiency and at sufficient pressure ratio to meet the air requirements of the emissionized engine. Efficient operation is generally achieved when the turbocharger 2 is operating at a lower volumetric inlet volume and a high-pressure ratio. This can be visually represented as the exemplary performance map 30 illustrated in FIG. 2, wherein the operation of the turbocharger 2 is illustrated with respect to inlet volumetric flow rate (cubic meters per second (m³/sec), on the X-axis) and pressure ratio (outlet pressure/inlet pressure, on the Y-axis). The operating window of the turbocharger 2 is bound by the choke boundary 34 on the right and the surge boundary 36 on the left. Rotational velocity lines 38 are illustrated on the performance map 30 that represent the corresponding volumetric flow rates and pressure ratios of the turbocharger 2 while operating at the specific rotational velocity.

As disclosed, it is desirable to operate the turbocharger 2 at a point of operation that is highly efficient and produces sufficient pressure ratio to meet engine-operating requirements. Therefore, as the operation of the turbocharger 2 approaches the surge boundary 36, efficiency generally increases until surging occurs, wherein efficiency, flow, and pressure ratio decrease rapidly. For example, four exemplary operating conditions, or points of operation, are illustrated on the performance map 30 as points of operation 40-46. As can be seen, point of operation 40 is disposed a substantial distance away from the surge boundary 36. Thus, at point of operation 40 no surge precursors are experienced by the turbocharger 2, wherein a surge precursor is defined as any information that indicates the turbocharger is approaching a surging event, such as an instability in operating temperature or compressor discharge pressure. Analyzing point of operation 42, this point of operation is disposed closer to the surge boundary 36, whereat the turbocharger 2 operates at greater efficiency and higher pressure ratio compared to point of operation 40, but can experience the onset of surge, wherein surge precursors are exhibited without actually experiencing a surge. To be more specific, the onset of surge is defined as the point of turbocharger 2 operation wherein the volumetric flow rate is relatively low compared to a relatively high pressure ratio, thereby generating a condition wherein, although surging does not occur, the operation of the turbocharger exhibits surge precursors. At point of operation 44, the turbocharger 2 operates at yet greater efficiency and pressure ratio, however surge precursors increase, indicating the compressor is on the verge of unstable operation. At point of operation 46, the turbocharger experiences a surging event whereat efficiency, pressure ratio, and flow decrease rapidly. Mechanical damage can also occur if operation in surge is left to continue.

Referring again to FIG. 1, to predict the onset of surge and/or the proximity of a surging event, the turbocharger 2 is fitted with a control system 20 comprising a controller 26 connected in operational communication with a first sensor 22 and a second sensor 24 (generally referred to as sensors) that are disposed in operational communication with the air inlet 16. The sensors are capable of measuring the operating conditions of the air within the inlet 16 and supplying information (e.g., a signal) to the controller 26. In specific embodiments, the sensors are thermocouples capable of measuring the temperature within the air inlet, wherein the sensors operate at a high degree of accuracy (e.g., greater than or equal to about 99%) and at a frequency response greater than or equal to about 10 Hz.

In one embodiment, the controller 26 is capable of determining if the turbocharger 2 is exhibiting surge precursors, as well as determining the proximity of a surging event. The controller 26 is capable of these functions by employing the first sensor 22 and the second sensor 24 to provide temperature information (e.g., a temperature differential) about the air within the air inlet 16. The controller 26 can also compare the temperature information to memory to determine the proximity of a surging event.

These capabilities are based on the discovery that as a surging event approaches, a hot boundary layer of air migrates up the air inlet 16 (against the flow of the air therein) from the compressor 6. As the hot boundary layer advances, the temperature communicated to the controller 26 from the second sensor 24 increases as it is engulfed by the hot boundary layer, creating a temperature differential between the second sensor 24 and the first sensor 22. The presence of the temperature differential is the surge precursor as it indicates the hot boundary layer has reached the second sensor 24 and the turbocharger 2 is experiencing the onset of surge.

As the hot boundary layer further advances, the first sensor 22 is engulfed by the hot boundary layer, which causes the temperatures communicated to the controller 26 continue to increase as well as the temperature differential because the hot boundary layer comprises an internal temperature differential. As the boundary layer continues to advance past the first sensor 22, the temperatures communicated to the controller 26 continue to increase and the temperature differential continues to exist until the point of surging. Yet further, it has also been discovered that these surge precursors can be utilized to also determine the proximity of a surging event.

The ability to determine the proximity of a surging event is highly desirable because once this is determined, the controller 26 can alter the operating conditions of the turbocharger system to avoid surging, which prolongs the service life of the turbocharger 2, or the controller 26 may alter the operating conditions to achieve an increased efficiency, which reduces operating expenses.

In an exemplary embodiment, the second sensor 24 is positioned a distance of about 0.15 inches (0.381 cm) from the compressor 6, and the first sensor 22 and the second sensor 24 are positioned at an axial distance (axial with respect to the axis of the air inlet 16) equal to about 0.25 inches (0.635 cm) from one another. However, depending upon the specific design of the turbocharger 2 (e.g., compressor 6), air inlet 16, operating conditions, as well as the position of the sensors, and other variables, the configuration of the sensors will vary. The sensors can be positioned at any point along the length of the air inlet 16 that can provide sufficient information (e.g., a temperature differential) to the controller 26 to determine the onset of surge. In general, the sensors can be positioned less than or equal to about 12 inches, or more specifically, less than or equal to about 6 inches, or even more specifically, less than or equal to about 1 inch from the compressor 6.

The specific temperatures and/or temperature differentials that are indicative of the onset of surge will vary based on variables such as turbocharger 2 design (e.g., compressor design), air outlet 14 design (e.g., length or diameter), operating conditions, sensor positions, and others. Therefore, the controller 26 can compare the information received from the sensors to memory (e.g., an operational map, a look-up table, a data array, and so forth) to determine if the turbocharger 2 is experiencing the onset of surge and/or the proximity of a surging event.

The memory accessed by the controller 26 is desirably programmed by the manufacturer based upon experimental test results, however the information in the memory can be empirically determined by the controller 26 or the user. The memory can be connected in operational communication to the controller 26 or integral therein.

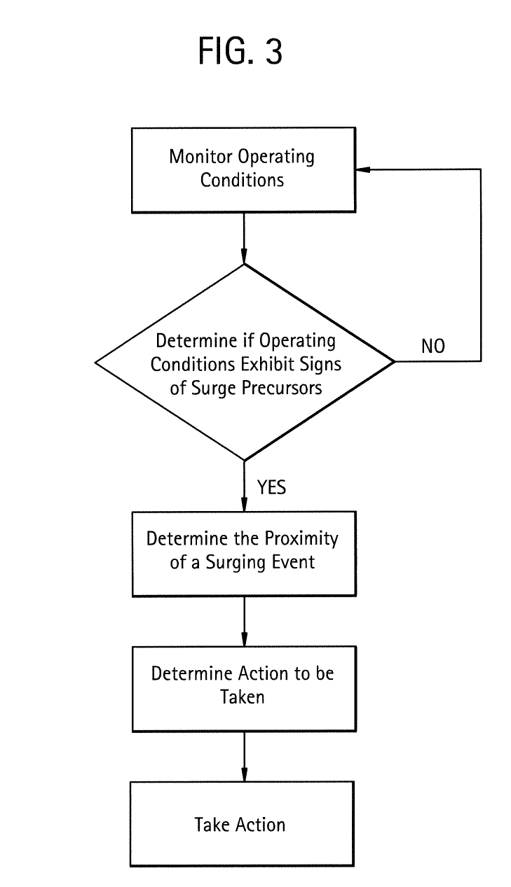

Referring now to the exemplary flowchart in FIG. 3, a method for detecting surge precursors and determining the proximity of a surging event is illustrated. In the first step of the method, the controller 26 monitors the operating conditions of the turbocharger 2 (e.g., a temperature differential) through communication with sensors. It is to be understood that in addition to temperature sensors additional sensors can be employed, such as pressure sensors, flow rate sensors, rotational velocity sensors, and so forth. Further, any number of additional sensors can be employed, which can be disposed in any configuration. Further, it is noted that the controller 26 advances through the method based on the completion of the step (e.g., determining a value, making a decision, acquiring a measurement, and so forth), elapsed time, at random, and so forth.

Next, the controller 26 determines if the turbocharger 2 is exhibiting surge precursors. This can be determined utilizing any of the operating conditions measured as well as memory (e.g., a performance map, look-up table, data, algorithms, and so forth). For example, the memory can consist of a look-up table wherein the controller 26 utilizes the current operating conditions (e.g., the temperature differential between the first sensor 22 and the second sensor 24) to look-up a limit, wherein if the operating conditions are above the limit the turbocharger 2 is exhibiting surge precursors, and if the operating conditions are below the limit the turbocharger is not exhibiting surge precursors. In one specific example, the temperature differential between a first temperature measurement supplied by the first temperature sensor 22 and a second temperature supplied by the second temperature sensor 24 can be determined by the controller 26 and, for example, compared to a limit within memory (e.g., look-up table). If the temperature differential is greater than or equal to the limit, the controller 26 determines that the turbocharger 2 is exhibiting a surge precursor. If the temperature differential is less than the limit, the controller 26 determines that the turbocharger 2 is not exhibiting a surge precursor.

In another embodiment, the memory can comprise a performance map, wherein the controller 26 utilizes the current operating conditions (e.g., rotational speed, flow rate, pressure ratio, and/or temperatures) to determine a current point of operation (see FIG. 2). The controller 26 can then determine if the current point of operation is within a range on the performance map, wherein the range is bound by the point at which surge precursors are exhibited and by the point at which surging occurs. If the current point of operation is within this range, the controller 26 will determine surge precursors are being exhibited.

In yet another embodiment, the current operating conditions of the turbocharger 2 can be employed to locate a specific algorithm within the memory, wherein the algorithm can be employed to calculate a point of operation whereat surge precursors are exhibited.

If the turbocharger 2 is not exhibiting signs of the onset of surge (e.g., surge precursors), the controller can continue to monitor the operating conditions and compare the operating conditions to memory as discussed above.

If the controller 26 determines the turbocharger 2 is exhibiting surge precursors (e.g., using wavelet function processor), the next step of the method can be initiated wherein the proximity of a surging event is determined. To be even more specific, the proximity of a surging event is a determination of when the turbocharger 2 will experience surge from the turbocharger's current point of operation. The proximity of a surging event can be determined utilizing any of the operating conditions measured as well as memory (e.g., a performance map, look-up table, data, algorithms, and so forth), and can be determined with respect to an operating condition. For example, the controller 26 can determine the turbocharger 2 will experience surge if the revolutions per minute (RPM) of the turbocharger reaches a certain value under the current operating conditions.

In another embodiment, the controller 26 can make use of converging or diverging trends in the temperature differential to determine the proximity of a surging event. In yet another embodiment, the controller 26 can determine a current temperature and the current rate of temperature change of the second temperature sensor 24. The current temperature and rate of temperature change can then be compared to a look up table to determine the proximity of the surging event via extrapolation. In yet another embodiment, the controller 26 can utilize the current operating conditions of the turbocharger 2 to locate a specific algorithm within the memory that can be employed to calculate a point of operation whereat surging will occur.

Once the controller 26 has determined if the turbocharger 2 is exhibiting signs of the onset of surge, and has determined the proximity of surge, the next step of the method is to determine the action to be taken. The action to be taken can be for any reason, such as to avoid surge or to increase the operating efficiency of the turbocharger 2. The determination can be made utilizing any of the operating conditions measured as well as memory (e.g., a performance map, look-up table, data, algorithms, and so forth). In one embodiment, the controller 26 can first determine if an action is desired to avoid surging by evaluating the proximity information determined in the prior step. If an action is not desired to avoid surging, the controller 26 can then evaluate if an action is desired to increase efficiency. To do so, the controller 26 can compare the temperatures supplied by the first sensor 22 and the second sensor 24, and the temperature differential therebetween, to a look-up table, wherein the look-up table provides information regarding the turbocharger's efficiency to the controller 26.

In another example, the controller 26 can determine that although the turbocharger 2 is operating at an acceptable efficiency, the proximity of a surging event is unacceptable, and therefore an action is performed to avoid surge.

The specific action determined by the controller 26 will depend upon the specific configuration of the turbocharger system. For example, the controller 26 can be connected to an operational device, such as backpressure valve disposed in fluid communication with the air outlet 14, wherein the backpressure valve is capable of bleeding off air to adjust the pressure ratio of the turbocharger 2 to avoid surging. In another embodiment, the controller 26 can be capable of controlling the operation of a pressure recycle circuit wherein a portion of the high pressure air from the air inlet 16 can be directed into the air outlet 14 to avoid surging. It is to be understood that additional devices and systems can be employed to avoid surging.

In the above methods, exemplary methods are disclosed for determining if surge precursors are being exhibited by a turbocharger 2 as well as methods for predicting the proximity of a surging event. It is to be apparent to those skilled in the art that many methods can be employed for these functions, such as employing mathematical prediction methods (e.g., algorithms, trend estimation, extrapolation, interpolation, and so forth), statistical methods (e.g., probability, regression analysis, and so forth), as well as other predictive methods.

In the previous embodiments temperature measurement is employed to determine if surge precursors are evident and to determine the proximity of a surging event. However, it has also been discovered that pressure-based surge precursors can also be identified, therefore enabling the use of pressure measurement to detect the onset of surge. Yet further, it has also been discovered that these pressure-based surge precursors increase in amplitude as a turbocharger's operation nears the surge boundary 36. Therefore, the proximity of a surging event can be determined.

To be more specific, as a turbocharger 2 approaches a surging event, it has been discovered that the signal received from a pressure sensor exhibits a significant increase in amplitude at frequencies less than or equal to about 10 Hz. Further, as the point of operation of the turbocharger 2 nears a surging event, the amplitude of these frequencies further increases.

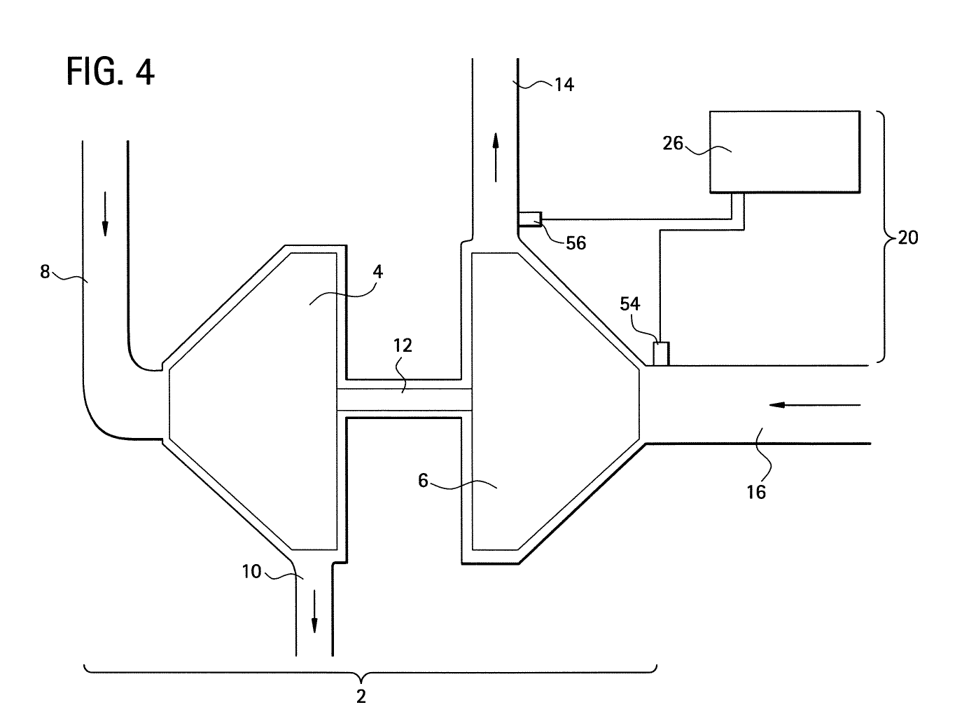

Referring now to FIG. 4, an alternative and exemplary embodiment of a control system 20 is illustrated, wherein the control system 20 is connected in operational communication to a turbocharger 2. The control system 20 comprises a controller 26 that is operably connected to a first pressure sensor 54 and a second pressure sensor 56 (collectively referred to as the pressure sensors), wherein the pressure sensors are capable of providing information (e.g., a signal) regarding the operating conditions of the turbocharger 2 to the controller 26.

The first pressure sensor 54 is disposed on the air inlet 16 and in operational communication with the air therein. The second pressure sensor 56 is disposed on the air outlet 14 and in operational communication with the air therein. In one specific embodiment, the first pressure sensor 54 is positioned at an axial distance (axial with respect to the axis of the air inlet 16) of about 0.15 inches (0.381 cm) from the compressor 6. The second pressure sensor 56 is positioned at an axial distance (axial with respect to the axis of the air outlet 14) of about 0.15 inches (0.381 cm) from the compressor 6. However, depending upon the specific design of the turbocharger 2 (e.g., compressor 6), air inlet 16, air outlet 14, operating conditions, as well as the position of the pressure sensors, and other variables, the configuration of the sensors will vary. The first pressure sensor 54 can be positioned at any point along the length of the air inlet 16, and the second pressure sensor 56 can be positioned at any point along the length of the air outlet 14, whereat they provide information (e.g., a pressure signal) to the controller 26 that is utilized to determine the onset of surge. In certain embodiments, the sensors can be positioned less than or equal to about 12 inches, or more specifically, less than or equal to about 6 inches, or even more specifically, less than or equal to about 1 inch from the compressor 6.

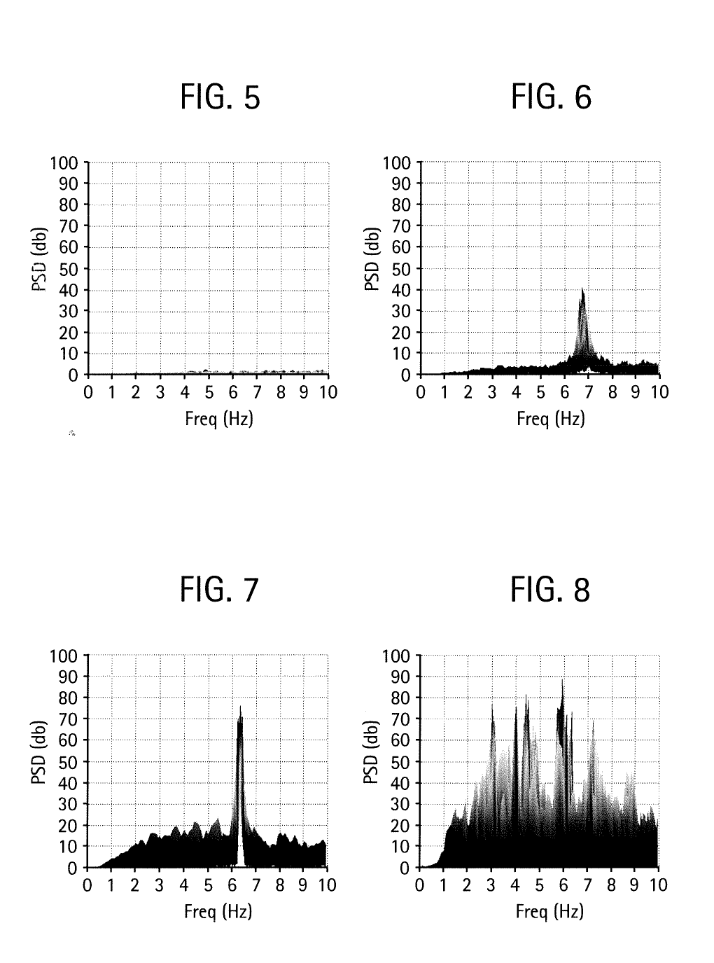

In the present embodiment, the controller 26 is capable of receiving an analog signal (e.g., millivolts) from each of the pressure sensors and evaluating each of the signals for surge precursors. To be more specific, frequencies of the signals that are less than or equal to about 10 Hertz (Hz) can be evaluated for amplitude peaks that are indicative of the onset of surging. For example, referring now to FIG. 5, a graph comprising signal frequency (units are hertz (Hz)) on the X-axis and signal amplitude (units are decibels (dB)) on the Y-axis illustrates the signal received from a pressure sensor (e.g., first pressure sensor 54) when a turbocharger 2 is operated at conditions that do not exhibit any indications of the onset of surge, such as at point of operation 40 illustrated in FIG. 2. In general, the graph plots power (e.g., strength) of the signal, and to be more specific, the power spectral density of the Fast Fourier Transform (FFT) of the signal. Since the signal is non-stationary when the turbocharger 2 is traversing through operating points or undergoes transients, a temporal FFT is used. For convenience, the power spectral density (PSD) on the Y-axis is scaled, normalized and plotted in decibels (dB). As can be seen, the signal does not exhibit any notable peaks (e.g., above 30 dB) at any of the frequencies less than or equal to about 10 Hz. Therefore, a turbocharger 2 operating at a point of operation that exhibits a graph similar to that illustrated in FIG. 5 does not exhibit surge precursors.

Referring now to FIG. 6, a graph illustrates the signal received from a pressure sensor (e.g., first pressure sensor 54) when a turbocharger 2 is operated at the onset of surge (e.g., surge precursors are exhibited), such as at point of operation 42 illustrated in FIG. 2. In this graph, a notable peak forms at about 6 to about 7 Hz having an amplitude that is greater than or equal to about 30 dB. To be more specific, the peak exhibits an amplitude of about 40 decibels (dB). Therefore, a turbocharger 2 operating at a point of operation that exhibits a graph similar to that illustrated in FIG. 6 is exhibiting surge precursors at about 6 to about 7 Hz.

Referring now to FIG. 7, a graph illustrates the signal received from a pressure sensor (e.g., first pressure sensor 54) when a turbocharger 2 is operated at a point of operation close to the surge boundary 36 (e.g., surge precursors are exhibited), such as at point of operation 44 illustrated in FIG. 2. In this graph, the peak formed at about 6 to about 7 Hz from FIG. 6 has increased in amplitude to about 70 dB. The peak amplitude is greater than or equal to about 30 dB, and is therefore a surge precursor, however, it is noted that as the point of operation approaches surging (e.g., the surge boundary 36), the amplitude of the peaks exhibited increase.

Lastly, referring now to FIG. 8, a graph illustrates the signal received from a pressure sensor (e.g., first pressure sensor 54) when a turbocharger 2 is operated in surging conditions, such as at point of operation 46 illustrated in FIG. 2. In this graph, significant peaks (e.g., peaks having an amplitude greater than or equal to about 30 dB) are exhibited at almost all of the frequencies less than or equal to about 10 Hz (e.g., from about 1.5 Hz to about 10.0 Hz)).

From FIGS. 5, 6, 7 and 8, it can be determined that a surge precursor is any signal peak having a frequency less than or equal to about 10 Hz that exhibits an amplitude greater than or equal to about 30 dB. However, it is to be understood that the specific frequencies at which a surge precursor originates will vary based on turbocharger 2 design, operating conditions, position of sensors, and so forth. Therefore, any range wherein a surge precursor can be identified can be employed. For example, in one embodiment a range between about 3.0 Hz to about 12.5 Hz can be employed.

In addition, it is to be apparent that although the turbocharger 2 and control system 20 illustrated in FIG. 4 utilize two pressure sensors (e.g., first pressure sensor 54 and second pressure sensor 56), one pressure sensor can be employed to provide sufficient information to detect surge precursors.

To detect surge precursors using pressure measurement signals, a wavelet function processor is employed to dissect the signal into discrete frequency ranges (bands) using a wavelet transform function. The wavelet function processor can be operably connected to the controller 20 or part thereof. This advantageously allows for the monitoring of discrete frequency bands of interest for surge precursors (e.g., changes in signal amplitudes).

Although not bound by theory, wavelet transforms are especially useful in this application as they are capable of extracting frequency information without losing time information. In addition, compared to Fourier transforms, wavelet transforms are especially effective at accounting for non-stationary signals having frequency transients, yield improved time-frequency resolution, and are computationally more efficient.

The controller 20 can employ any sampling rate for the information received from the sensors, however the rate is to be sufficient to adequately predict a surging event. In general, the frequency employed should be greater than about 0.01 Hz, such as greater than about 1.0 Hz, or greater than about 100.0 Hz. In one example, the controller can receive information at about 400 Hz.

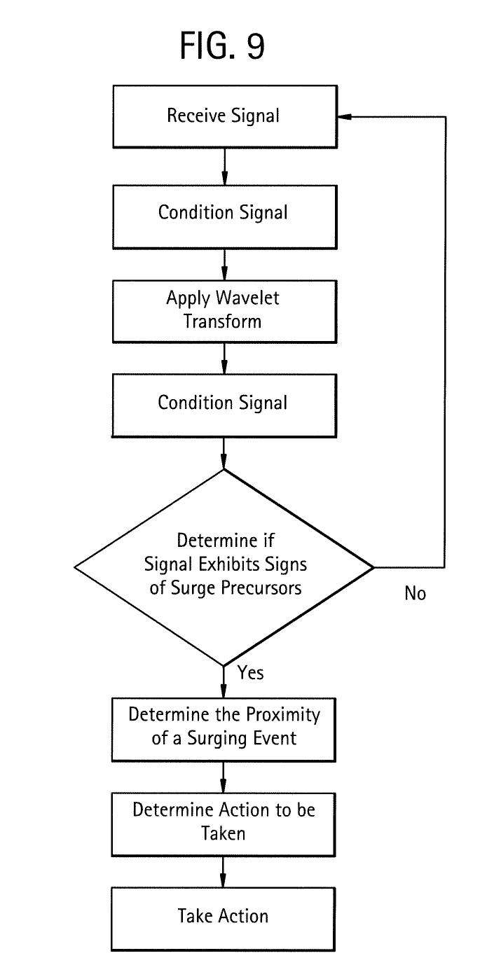

Referring now to FIG. 9, a flow chart illustrates an exemplary process employing a wavelet function processor. In the first step of the process, the controller 26 receives a signal, wherein the signal in the present embodiment is envisioned to be an analog signal from the pressure sensors (first pressure sensor 54 and second pressure sensor 56). Once received, the signal is conditioned by the controller 26 or by a component operably connected thereto, such as a buffer, filter, amplifier, algorithm, analog to digital converter, and so forth, as well as combinations comprising at least one of the foregoing. For example, a buffer can be employed to accumulate data in interval windows (e.g., 1.0 second). It is noted however that in alternative embodiments the interval window can smaller such that data can be tracked more rapidly. Suitable alternative windowing functions can also be employed.

Once the signal has been buffered, the conditioned signal (e.g., signal block data) is decomposed into several different frequency ranges using a wavelet function processor. The extracted signal (e.g., of the specific frequency range of interest, e.g. 0-12.5 Hz) is then further conditioned using a root-mean-square block wherein the square root of the mean of the squares of the specific frequency range values is calculated to produce a root mean squared value (RMS value). The RMS value is then passed through a moving average filter to give the final signal called as ‘final processed signal’.

The final processed signal for the specific frequency(ies) (e.g., a singular frequency or multiple frequencies of interest) is then evaluated by the controller 26 to determine if the turbocharger 2 is exhibiting signs of surge precursors. This can be determined utilizing any of the operating conditions measured as well as memory (e.g., a performance map, look-up table, data, algorithms, and so forth). For example, the final process signal can be evaluated for peaks having an amplitude greater than or equal to a specified limit, such as about 30 dB.

If the turbocharger 2 is not exhibiting signs of the onset of surge (e.g., surge precursors), the controller can continue to monitor the operating conditions and compare the operating conditions to memory as discussed above.

If the controller 26 determines the turbocharger 2 is exhibiting surge precursors, the next step of the method is initiated wherein the proximity of a surging event is determined. To be even more specific, the proximity of a surging event is a determination of when the turbocharger 2 will experience surge from the turbocharger's current point of operation. The proximity of a surging event can be determined utilizing any of the operating conditions measured as well as memory (e.g., a performance map, look-up table, data, algorithms, and so forth), and can be determined with respect to time or with respect to an operating condition. For example, the controller 26 can determine the turbocharger 2 will experience surge if the RPM of the turbocharger reaches a certain value under the current operating conditions.

In another embodiment, the controller 26 can determine the proximity of a surging event by determining the current amplitude of a peak and the current rate of change in the peak's amplitude. Thereafter, the amplitude of the peak and the current rate of change in the peak's amplitude can be compared to a look up table to determine the proximity of the surging event via extrapolation. In yet another embodiment, the controller 26 can utilize the current operating pressures to locate a specific algorithm within the memory that can be employed to calculate a point of operation whereat surging will occur.

Once the controller 26 has determined if the turbocharger 2 is exhibiting surge precursors, and has determined the proximity of surge, the controller can then determine if an action is desired. The action to be taken can be for any reason, such as to avoid surge or to increase the operating efficiency of the turbocharger 2. If the action is desired, the action is performed.

As discussed prior, in one embodiment, the controller 26 can first determine if an action is desired to avoid surging by evaluating the proximity information determined in the prior step. If an action is not desired to avoid surging, the controller 26 can then evaluate if an action is desired to increase efficiency. To do so, the controller 26 can compare the temperatures supplied by the first sensor 22 and the second sensor 24, and the temperature differential therebetween, to a look-up table, wherein the look-up table provides information regarding the turbochargers efficiency to the controller 26. Based on the efficiency information, the controller 26 compares the turbochargers current efficiency to a minimum value. If above the minimum value, the controller determines no action is to be taken except to continue to monitor the operating conditions of the turbocharger 2. In another example, the controller 26 can determine, that although the turbocharger 2 is operating at an acceptable efficiency, the proximity of a surging event is unacceptable, and therefore an action is performed to avoid surge.

As discussed earlier, the control system 20 can comprise an operational device. One exemplary device is a backpressure valve disposed in fluid communication with the air outlet 14 wherein the backpressure valve is capable of adjusting the pressure ratio of the turbocharger 2 to avoid surging (not shown). The controller 26 can also or alternatively, be capable of controlling the operation of a pressure recycle circuit wherein a portion of the high pressure air from the air outlet 14 can be directed into the air inlet 16 to avoid surging. It is to be understood that additional devices and systems can be employed to avoid surging and/or adjust the operating conditions of the turbocharger (e.g., open a bypass valve, increase air outlet 14 flow, increase exhaust inlet 8 flow, and so forth).

The methods disclosed above can be embodied in the form of computer-implemented processes. These methods can also be embodied in the form of computer program code embodied in tangible media, such as floppy diskettes, CD-ROMs, hard drives, or any other computer-readable storage medium, wherein, when the computer program code is loaded into and executed by a computer or controller, the device executing the code is an apparatus for practicing the method. When implemented on a general-purpose microprocessor, the computer program code segments configure the microprocessor to create specific logic circuits.

To be specific, the technical effect of the actions of the controller 26 is the monitoring and/or control of a turbocharger and/or the determination of the presence of surge precursors and/or the determination of the proximity of a surging event. When these capabilities are embodied in software, firmware, hardware or some combination thereof, the embodiment can be an individual article for sale or included as a part of a computer system or sold separately.

The flow diagrams depicted herein are examples. There may be many variations to these diagrams or the steps (or operations) described therein without departing from this disclosures spirit. For instance, the steps may be performed in a differing order, or steps may be added, deleted or modified.

The turbocharger systems disclosed herein provide several notable benefits. Firstly, turbocharger systems are disclosed that can determine the presence of surge precursors. Second, using operating information regarding the surge precursors, the turbocharger systems can determine the proximity of a surging event. This enables the controller to determine if an action is required to avoid a surging event or adjust the operating conditions closer to the surge boundary to achieve greater operating efficiency. Third, turbocharger systems are disclosed that employ pressure and/or temperature sensors (e.g., operating condition(s) can be determined by monitoring (i) a temperature differential in an air inlet connected in fluid communication to the compressor, and/or (ii) a pressure), providing flexibility in the design and configuration of the turbocharger system. For example, in many cases thermocouples are less expensive than pressure transducers. Finally, methods for operating turbochargers are disclosed that provide for efficient operation and extended service life due to avoiding surging events.

Unless defined otherwise, technical and scientific terms used herein have the same meaning as is commonly understood by one of skill in the art to which this invention belongs. Reference throughout the specification to “one embodiment”, “another embodiment”, “an embodiment”, and so forth, means that a particular element (e.g., feature, structure, and/or characteristic) described in connection with the embodiment is included in at least one embodiment of the present invention. Thus, the element(s) are not necessarily all referring to the same embodiment, and particular elements may be combined in any suitable manner in the various embodiments. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., “the colorant(s)”, includes one or more colorants). Furthermore, as used herein, “combination” is inclusive of blends, mixtures, alloys, reaction products, and the like.

While the turbocharger control systems described are in reference to exemplary embodiments, it will be understood by those skilled in the art that various changes may be made and equivalents may be substituted for elements thereof without departing from the scope. In addition, many modifications may be made to adapt a particular situation or material to the teachings of the turbocharger control systems without departing from the essential scope thereof. Therefore, it is intended that the invention not be limited to the particular embodiment disclosed as the best mode contemplated for carrying out this invention, but that the invention will include all embodiments falling within the scope of the appended claims.

1. A turbocharger system comprising:
a turbocharger comprising a turbine and a compressor, wherein the turbine is mechanically connected to the compressor;
an air inlet connected in fluid communication to the compressor;
a first sensor and a second sensor disposed in operational communication with the air inlet, wherein the first sensor and second sensor are disposed a sufficient distance from one another for measuring a temperature differential between the first sensor and the second sensor; and
a controller connected in operational communication with the first sensor and the second sensor, wherein the controller is configured to detect surge precursors.

2. The turbocharger of claim 1, wherein the surge precursor is a temperature or a temperature differential.

3. The turbocharger of claim 1, further comprising a wavelet function processor connected in operational communication to the controller.

4. A turbocharger system comprising:
a turbine and a compressor, wherein the turbine is mechanically connected to the compressor;
an air inlet connected in fluid communication to the compressor;
an air outlet connected in fluid communication to the compressor;
a first pressure sensor connected in operational communication with the air inlet;
a second pressure sensor connected in operational communication with the air outlet;
a wavelet function processor connected in operational communication with the first pressure sensor and the second pressure sensor; and
a controller connected in operational communication with the wavelet function processor.

5. The turbocharger of claim 4, wherein the surge precursor is a signal having a peak, wherein the peak has an amplitude greater than or equal to a specified limit.

6. The turbocharger of claim 5, wherein the peak has a frequency of less than or equal to about 10 Hz.

7. A method for controlling the operation of a turbocharger comprising:
monitoring a temperature differential in an air inlet connected in fluid communication to a compressor;
determining if the temperature differential is a surge precursor; and
determining if an action to regulate the operation of the turbocharger is desirable to avoid surge or to increase operation efficiency, wherein if an action is desired, performing the action.

8. The method of claim 7, further comprising determining the proximity of a surging event.

9. The method of claim 7, further comprising processing the signal using a wavelet function processor.

10. A method for controlling the operation of a turbocharger comprising:
monitoring a pressure using a controller, wherein the pressure is supplied to the controller in the form of a signal;
determining if the signal exhibits a surge precursor; and
determining if an action to regulate the operation of the turbocharger is desirable to avoid surge or to increase operation efficiency, wherein if an action is desired, performing the action.

11. The method of claim 10, wherein determining if the signal exhibits a surge precursor comprises determining if the signal has a peak having an amplitude greater than or equal to a specified limit.

12. The method of claim 11, wherein the specified limit is about 30 decibels.

13. The method of claim 10, wherein determining if the signal exhibits a surge precursor comprises determining if the signal has a peak having a frequency of less than or equal to about 10 Hz.

14. The method of claim 10, further comprising processing the signal using a wavelet function processor.

15. The method of claim 10, further comprising determining the proximity of a surging event.

16. The method of claim 10, wherein the action comprises adjusting the operation of the centrifugal turbocharger to avoid surging.

17. A method for controlling the operation of a turbocharger comprising:
receiving a signal by a controller from a sensor, wherein the sensor is disposed in operational communication with the centrifugal turbocharger;
processing the signal using a wavelet transform processor to produce a frequency band;
determining if the frequency band exhibits a surge precursor; and
determining if an action to regulate the operation of the turbocharger is desirable to avoid surge or to increase operation efficiency wherein if an action is desired the controller performs the action.

18. The method of claim 17, wherein determining if the frequency band exhibits a surge precursor comprises determining if the frequency band comprises a signal having a peak that has an amplitude greater than or equal to a specified limit.

19. The method of claim 18, wherein the specified limit is about 30 decibels.

20. The method of claim 17, wherein the frequency band has a frequency of less than or equal to about 10 Hz.

21. The method of claim 17, further comprising determining the proximity of a surging event.

22. The method of claim 17, wherein the action comprises adjusting the operation of the centrifugal turbocharger to avoid surging.
